(19) United States
(12) Patent Application Publication
(10) Pub. No.: US 2010/0251787 A1
(43) Pub. Date: Oct. 7, 2010

(54) Micro Motor Locking System

(75) Inventors: Vehbi Dayanikli, Bursa (TR); Mustafa Dayanikli, Bursa (TR)

Correspondence Address: AKERMAN SENTERFITT, P.O. BOX 3188, WEST PALM BEACH, FL, 33402-3188, US

(73) Assignee: Vemus Endustriyel Elektronik Sanayi Ve Ticaret Limited Sirketi, Bursa (TR)

(21) Appl. No.: 12/744,845

(22) PCT Filed: Feb. 5, 2009
(86) PCT No.: PCT/TR09/00017

§ 371 Date: May 26, 2010

(30) Foreign Application Priority Data
Mar. 24, 2008 (TR) 2008/01927

(51) Int. Cl. E05B 47/06; E05B 15/04

(52) U.S. Cl. 70/277

(57) ABSTRACT

The invention relates to locking systems to realize locking function in embodiments such as electronic gates, drawers, cabinets, safes and similar things and it consists of linear motion transmission member (3) performing motion on a worm gear (2) to provide linear motion, angular motion transmission member (4) providing angular motion together with linear motion transmission member (3), guiding member (7) pushing, pulling and guiding angular motion transmission member (4) and linear motion transmission member (3) at the same alignment, motion transmission member (6) moving lock bolt (5) up and down, providing locking and unlocking, compressing the angular motion transmission member (4) in reverse direction and thus enabling the motor (1) to complete its cycle.

### THE RELATED ART

The invention relates to micro engine locking system providing locking of embodiments such as electronic gate, drawers, cabinet, safe and similar ones, consisting of linear motion transmission member following the worm gear and moving linearly, angular motion transmission member providing increase in power and converting linear motion into angular motion, guiding member converting the motion received from the said angular motion member into linear motion and thus providing guidance, motion transmission member moving the lock up and down by use of the linear motion received from the guiding member and thus providing advantages such as lower power requirement, lower cost and secure locking distance.

### BACKGROUND OF THE RELATED ART

Today it is known that embodiments such as electronic gate, drawers, cabinets, safe and similar things are used for controlled passing systems. In such types of locking systems the user enters his/her password by use of key set and the aim is to provide a secure and safe passing.

In the existing electronic locks, electromagnet bobbin (solenoid bobbin) is used. Such bobbins consume too much power during locking or unlocking. And this causes burning of driving centre.

In the known related art, too much power is consumed for the voltage and ampere values in locking systems and this causes short operating life of electronic locking systems.

In the existing status of the related art, electro-magnets are user in other electronic locking system. In such systems the position can be changed by means of spontaneous power. However, in such systems lock can leave the housing easily that is, the locking distance is considerably short. And this causes removal of the lock from the housing with a small stroke.

In the related art, the sizes of electronic locking systems are too big and number of parts is too many, which causes increase in cost of production and problem in aesthetics.

In the related art, electronic locking systems are not secure due to the reasons given above, which cause risk on life of people and problems in safety.

In the related art, several embodiments related to electronic locking systems are known. One of those embodiments is disclosed under Korean patent application numbered KR20030019541 where an electronic locking system in which security is ensured by means of a secret password entrance or remote control is disclosed. The battery on the body of the locking system is used as power source. Locking member is within locking part and locking is provided in this way.

Another application is the German Patent application numbered DE19812276 which relates to locking mechanism developed for use in buildings. The locking mechanism which is unlocked by use of key can also be unlocked by use of a circuit switch. The electric power in such locking system is converted into motion power by means of electrical magnet or motor.

In conclusion, developments in parallel to development in electronic locks are made and for that reason, it has been needed to make new embodiments which will eliminate the disadvantages mentioned above and bring solution to current systems.

### PURPOSE OF THE INVENTION

The present invention relates to a locking system of micro driving centered lock meeting the above mentioned requirements, eliminating all disadvantages and bringing some additional advantages.

The purpose of the invention is to provide electronic locking system having micro driving lock requiring less power.

Another purpose of the invention is to provide smaller sizes and decrease number of parts to reduce cost and thus provide a locking system of good aesthetic appearance.

A further purpose of the invention is to provide an electronic locking system consisting of micro driving lock resistant against strokes ensuring secure locking.

Another purpose of the invention is to provide a long life locking system by means of preventing burning of driving center.

A further purpose of the invention is to provide a locking system ensuring comfort in addition to security feeling for the user.

A further purpose of the invention is to provide cost decrease by means of electronic locking system.

Another purpose of the invention is to provide an electronic locking system operating at lower voltages.

One of the most important purposes of the invention is to provide a secure locking distance.

In order to realize all the advantages mentioned above and to be better understood from the detailed description provided below, the invention is to develop a micro motor lock system, consisting of linear motion transmission member following the worm gear and moving linearly, angular motion transmission member providing increase in power and converting linear motion into angular motion, guiding member converting the motion received from the said angular motion member into linear motion and thus providing guidance, motion transmission member moving the lock up and down by use of the linear motion received from the guiding member, needing lower power requirement, ensuring lower cost due to less number of parts and small sites, capable to operate at lower voltages and providing secure locking distance.

The structural and characteristic features of the invention as well as all advantages will be better understood in the detailed description provided by use and reference to the figures given below, and for that reason the assessment should be made based on the said figures and detailed description.

### BRIEF DESCRIPTION OF THE FIGURES

In order that the embodiment and additional members as well as all advantages be better understood, the assessment should be made based on the said figures described below.

FIG. 1 Upper two dimensioned view of the representative sample of the lock used in the micro motor locking system being subject of the invention.

FIG. 2 Upper two dimensioned view of the representative sample of another lock used in the micro motor locking system being subject of the invention.

FIG. 3 Side perspective view of another representative sample of lock used in the micro motor locking system being subject of the invention.

FIG. 4 Upper two dimensioned view of another representative sample of lock used in the micro motor locking system being subject of the invention.

FIG. 5 Upper two dimensioned view of representative sample of lock system of the invention in open position.

FIG. 6 Upper two dimensioned view of representative sample of lock system of the invention in close position.

FIG. 7 Front perspective view of representative sample of lock system of the invention in open position.

FIG. 8 Front perspective view of representative sample of lock system of the invention in close position.

FIG. 9 Upper representative view of the locking system being subject of the invention.

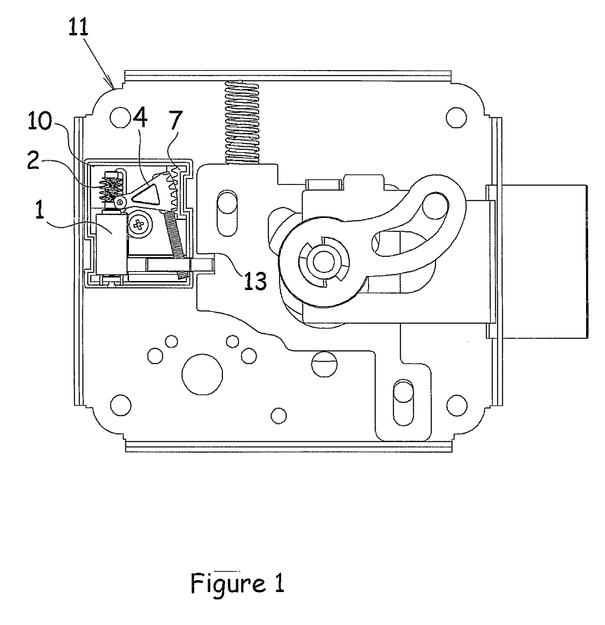

### REFERENCE NUMBERS

1. Motor
2. Worm gear
3. Linear motion transmission member
3.1 Connection member
3.2. Connection member housing
4. Angular Motion transmission member
4.1. Compression members
4.2. Angular motion transmission member side surfaces
4.3. Gears
5. Lock
5.1. Motion transmission member housing
6. Motion transmission member
7. Guiding member
7.1. Guidance Member Gears
8. Micro motor locking system
9. Body Housing
10. Support body
11. Lock
12. Power source
13. Locking housing

### DETAILED DESCRIPTION OF THE INVENTION

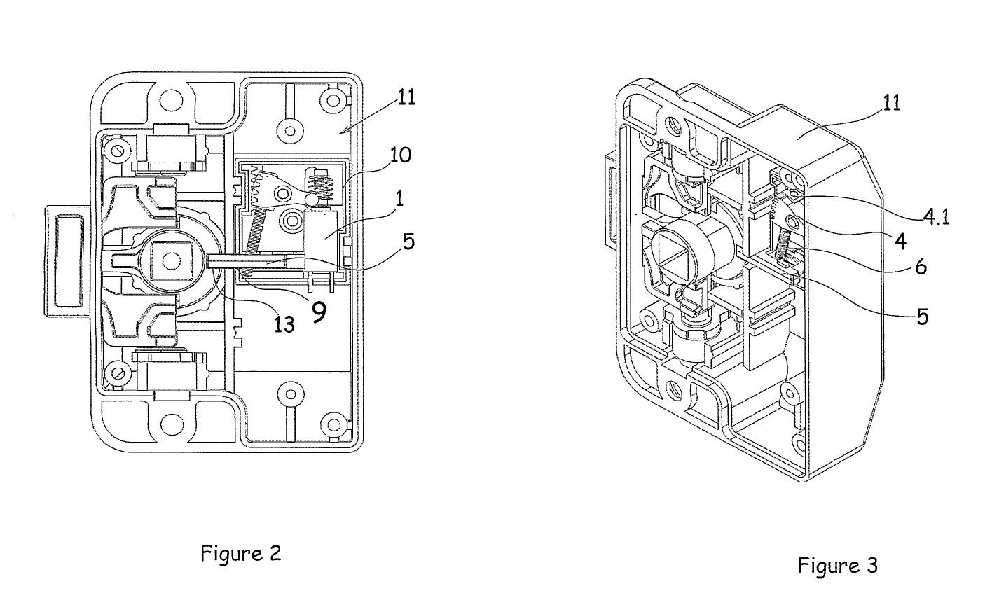

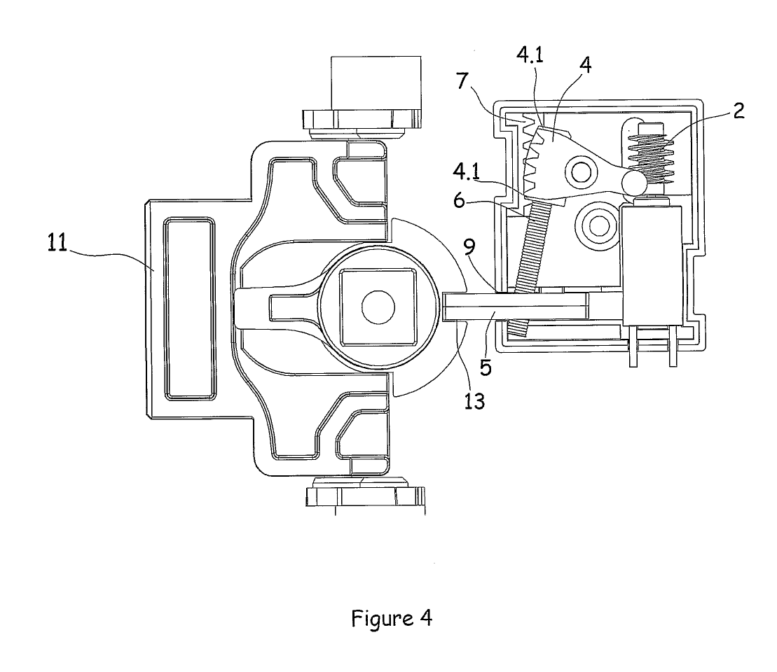

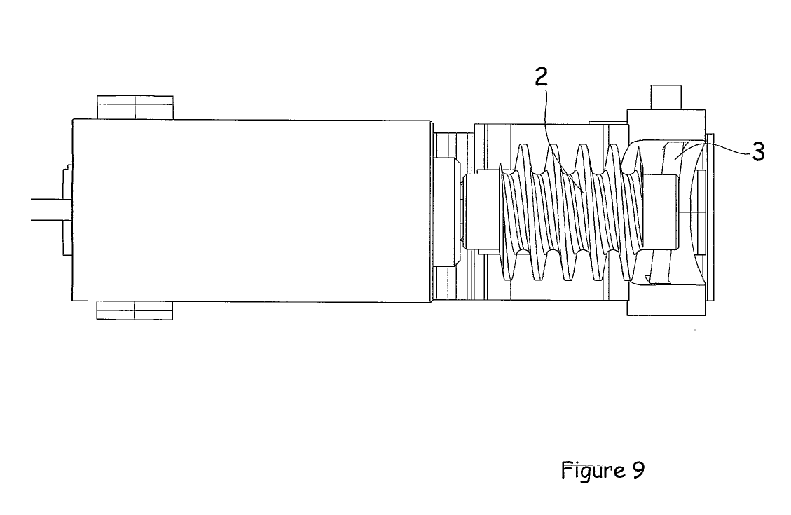

In this detailed description of the invention, the preferred embodiments of the micro motor locking system (8) being subject of this invention have been described only for the purpose of better understanding of the subject without any restrictive effects. FIG., 1, FIG. 2, FIG. 3, and FIG. 4 show lock samples where the micro motor lock system is used. Micro motor locking system (8) consists of motor (1) providing rotation motion, worm gear (2) converting the rotation motion into linear motion, linear motion member (3) following the said worm gear (2) and providing linear motion thereon, lock (5) entering in the lock housing (13) on the lock (11) and providing unlocking by means of removal from the housing (13), motion transmission member (6) moving the lock (5) up and down and providing entrance and removal of the lock (5) into/from housing (13) and thus providing locking; angular motion transmission member (4) supporting linear motion transmission member (3) and motion transmission member (6) guiding member (7) providing forward-backward motion of linear motion transmission member (3) shown in FIG. 7 at the same alignment. The said motor (1) is connected to worm gear (2). It is connected to the housing (3.2) located on the angular motion transmission member (4) via connection members (3.1) of the linear motion transmission member (3). As seen in FIG. 9, the said linear motion transmission member (3) is located in angular position in respect to step pitch of the worm gear (2). Thus the worm gear (2) moves the linear motion transmission member (3) and angular motion transmission member (4) where it is connected, forward and backward without much force. The said linear motion transmission member (3) is preferably spindle. The said angular motion transmission member (4) is preferably integral with linear motion transmission member (3). It is the angular motion transmission member (4) on which is located linear motion transmission member (3), which converts the linear motion received from the linear motion transmission member (3) into angular motion and has gears (4.3). The said angular motion transmission member (4) is preferably spring gear. Compression member (4.1) is located on side surfaces (4.2) of the angular motion transmission member. As shown in FIG. 8, motion transmission member (6) is located on the side surfaces (4.2) of the angular motion transmission member. The said motion transmission member (6) is preferably spring. Here elastic members made of hard plastic and derivatives conducting the same functions can be used instead of spring. One end of the said motion transmission member (6) shown in FIG. 7 is connected to angular motion transmission member (4) and the other end is connected to the housing (5.1) located on the lock (5). It consists of a guiding member (7) converting the motion of the said angular motion transmission member (4) into linear motion and guiding the said angular motion transmission member (4) and having gears (7.1) connected to the said angular motion transmission members (4) gears (4.3). It is the motion transmission member (6) which transmits the linear motion received from the said guiding member (7) to lock (5). The said guiding member (7) is preferably Kramayer gear.

The said motion transmission member (6) performs the following functions;
Moving the lock bolt (5) up and down and thus providing locking or unlocking.
Getting worm gear (2) ready for catching the linear motion transmission member (3) while the linear motion transmission member (3) moves in next rotation direction. Compressing the angular motion transmission member (4) in reverse direction.
In case of compulsion that is struck of lock bolt (5), providing completion of tour of the motor (1) without fault in the motor (1). Thus locking or unlocking is provided upon end of compulsion (striking).

The said linear motion transmission member (3) pushes or pulls the angular motion transmission member (4) at the same alignment ensuring following of the angular motion transmission member (4) of guiding member (7). In addition, power increased is provided in respect to rate of obtained gear wheel division. Thus, too short motor (1) rotation time is adequate. So compression and broken out of the motor caused by continuation of idle rotation of the motor (1) after completion of operation (motors (1) failing to rotate consume too much power).

As shown in FIG. 2 and FIG. 3, micro motor locking system (8) is mounted on the support body (10). A housing (9) is located on the said supporting body (10). Thus the said lock bolt (5) leaves the housing (9) located on the body (10) and easily enters and leaves the locking housing (13). In addition, sensors are used to understand if locking operation is realized or not.

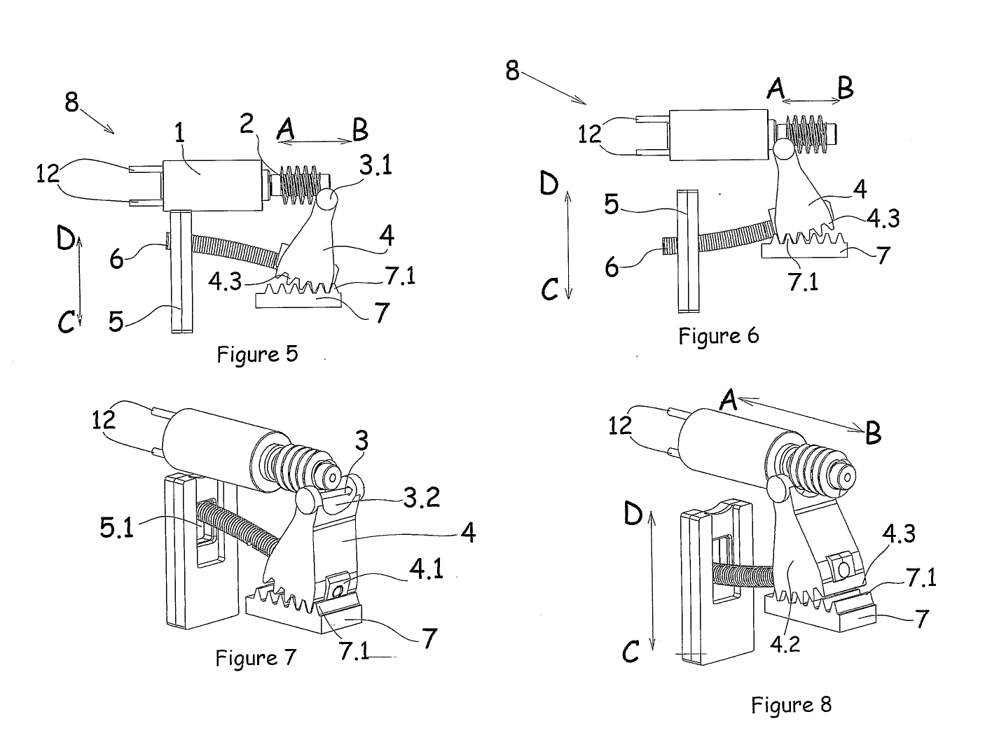

Changing from open (unlock) position as shown in FIG. 5 and FIG. 7 into close (lock) position shown in FIG. 6 and FIG. 8 by the locking system (8) being subject of the invention is conducted as follows:
operation of the motor (1) by the power from power source (12)
motion to the worm gear (2) by the motor (1),
rotation motion by the worm gear (2),
motion of linear motion transmission member (3) located on angular motion transmission member (4) in A direction on the worm gear (2),
Pulling of linear motion transmission member (3) in A direction at the same alignment in a manner following guiding member (7),
Motion of angular motion transmission member (4) and motion transmission member (6) and lock bolt (5) in down direction (C direction) as shown in FIG. 6 and FIG. 8;
realization of locking operation upon sitting of the lock bolt (5) into the locking housing (13) located on the said lock (11),

Changing from close (lock) position as shown in FIG. 6 and FIG. 8 into open (unlock) position shown in FIG. 5 and FIG. 7 by the locking system (8) being subject of the invention is conducted as follows:
operation of the motor (1) by the power from power source (12)
motion to the worm gear (2) by the motor (1),
reverse direction rotation motion by the worm gear (2),
motion of linear motion transmission member (3) located on angular motion transmission member (4) in B direction on the worm gear (2)
Pulling of linear motion transmission member (3) in B direction at the same alignment in a manner the angular motion transmission member (4) follows guiding member (7),
Motion of angular motion transmission member (4) and motion transmission member (6) and lock bolt (5) in up direction (D direction);
removal of the lock bolt (5) from the locking housing (13) on the said lock (11) and coming into unlock position and thus realization of unlocking operation,

The protection scope of this application is specified under claims and cannot be restricted to the descriptions given only for demonstration purposes. It is clear that any innovation to be provided by a person skilled in the art by means of change in parts in form and use of similar embodiments can be applied in other areas for similar purposes. Therefore, it is obvious that such embodiments will lack criteria of invention.

1. A locking system comprising:
a motor;
a worm gear converting the motion from the said motor into a rotation motion;
a lock bolt adapted to enter into a lock housing upon motion from the motor defining a locking position and to remove from the locking housing defining an unlocking position;
a linear motion transmission member driven by said worm gear, moving on said worm gear and thus providing linear motion;
an angular motion transmission member supporting said linear motion transmission member, providing angular motion together with said linear motion transmission member with the motion received from said linear motion transmission member;
a guiding member serving as a housing for said angular motion transmission member and pulling and pushing said angular motion transmission member and linear motion transmission member at the same alignment, and guiding said angular motion transmission member and linear motion transmission member; and
a motion transmission member connected on the angular motion transmission member and moving the lock bolt up and down and providing locking and unlocking, keeping the angular motion transmission member under pressure in reverse direction and enabling the motor to complete its tour by rotating.

2. The locking system according to claim 1, wherein the linear motion transmission member is a spindle.

3. The locking system according to claim 1, wherein the angular motion transmission member is a spring gear.

4. The locking system according to claim 1, wherein the guiding member is a Kramayer gear.

5. The locking system according to claim 1, comprising gears on the angular motion transmission member.

6. The locking system according to claim 1, comprising a compressing member on the angular motion transmission member compressing the said motion transmission member to prevent removal.

7. The locking system according to claim 1, wherein the guiding member comprises gears.

8. The locking system according to claim 1, wherein the motion transmission member is a spring.

9. The locking system according to claim 1, wherein the motion transmission member is an elastic material made of hard plastic and derivatives.

10. The locking system according to claim 1, comprising a connection member connecting said linear motion transmission member and said angular motion transmission member.

11. The locking system according to claim 10, comprising a connection member housing providing location of the connection member on the angular motion transmission member.

12. The locking system according to claim 10, comprising a supporting body providing mounting of the locking system on the lock.

13. The locking system according to claim 12, comprising a body housing providing entrance and removal of the lock bolt on the supporting body.

14. The locking system according to claim 12, wherein the guiding member is integral on the supporting body.

15. The locking system according to claim 1, wherein the linear motion transmission member is at an angular position in respect to worm gear.

16. The locking system according to claim 1, wherein the said motion transmission member is adjacent to a wound spring.

17. A locking method to realize a locking function wherein a motion is provided from a motor, a worm gear converts the motion from the motor into rotation motion, a lock bolt enters into a locking housing upon motion from the motor and thus realizes a locking position, and the lock bolt leaves the locking housing to provide an unlocking position; the method comprising the steps of:
realization of linear motion of a linear motion transmission member on the worm gear upon driving of the linear motion transmission member by the worm gear;
conversion of linear motion received from the linear motion transmission member having the linear motion transmission member by means of an angular motion transmission member;
conversion of angular motion into linear motion by a guiding member housing the angular motion transmission member pulling and pushing the motion transmission member and linear motion transmission member at the same alignment; and
compression of the angular motion transmission member in reverse direction by the motion transmission member connected on the angular motion transmission member, moving the lock bolt up and down and providing locking and unlocking, and thus enabling the motor to rotate and to complete the cycle.

18. A locking method to realize a locking function comprising the steps of
moving a linear motion transmission member located on an angular motion transmission member in B or A direction on the worm gear,
pulling or pushing of the angular motion transmission member by the linear motion transmission member in B or A direction in the same alignment in a manner following a guiding member,
moving the angular motion transmission member and a transmission member together with a lock bolt in an up or down direction, and
removing the lock bolt from the locking housing on the lock and coming into an unlocking open position and thus unlocking or inserting the lock bolt into the locking housing on the lock and realizing a locking close position.
